(19) United States
(12) Patent Application Publication
(10) Pub. No.: US 2003/0223428 A1
(43) Pub. Date: Dec. 4, 2003

(54) Method and apparatus for scheduling aggregated resources

(76) Inventors: Jose Maria Blanquer Gonzalez, Goleta, CA (US); Banu Ozden, Summit, NJ (US)

Correspondence Address: Ryan, Mason & Lewis, LLP, Suite 205, 1300 Post Road, Fairfield, CT, 06430, US

(21) Appl. No.: 10/157,763

(22) Filed: May 28, 2002

(51) Int. Cl. H04L 12/28

(52) U.S. Cl. 370/395.4

(57) ABSTRACT

A system and apparatus are disclosed for proportional sharing of multiple servers among competing flows. Single server weighted fair queuing (WFQ) principles are extended to a multi-server system consisting of N servers each operating at a rate of r, referred to as a multi-server fair queuing (MSFQ) system, to provide an output rate of Nr. An aggregated resource scheduling process proportionally shares the multiple servers among the competing flows. MSFQ does not share some of the properties of WFQ. The MSFO system of the present invention closely approximates a GPS system in terms of the delay a packet can experience and the cumulative service a flow receives. A disclosed MSF²Q algorithm extends the single server work of the WF²Q system to provide bounded fairness and generate “smooth” schedules. The MSF²Q system restricts the packets eligible for scheduling using a packet regulator at the exit of the flow queues which delays the eligibility of the packets to the WFQ scheduler.

### FIELD OF THE INVENTION

The present invention relates to methods and apparatus for regulating traffic in a communications network and, more particularly, to a method and apparatus for scheduling aggregated or multiple server resources, capable of meeting quality of service (“QoS”) requirements.

### BACKGROUND OF THE INVENTION

A large increase in networked services has been gradually driving packet-switched networks to carry a much larger variety of traffic, including simple downloads of static web pages, multimedia streams and real-time trading. This increased variety of traffic is challenging the premises of the Internet's best-effort traffic, and demands different network requirements to be met simultaneously over the same links. For example, a network must often simultaneously provide high bandwidth, low jitter and packet delay guarantees to ensure the correct performance of continuous backups, video streaming and network data acquisition applications, respectively. In order to meet these diverse requirements, network resources must be appropriately scheduled.

Well-known Fair Queuing algorithms provide a method for proportionally sharing a single server among competing flows. Fair Queuing service disciplines address the scheduling problem by allocating bandwidth fairly among competing traffic, regardless of their prior usage or congestion. In particular, these disciplines do not penalize traffic for the use of idle bandwidth. Fair queuing algorithms are typically based on the Generalized Processor Sharing (GPS) approach, an idealized system that serves as a reference model for the fair queuing disciplines. GPS-based service disciplines are generally studied in the context of providing fairness as well as more strict Quality of Service (QoS) guarantees.

Fairness offers protection from “misbehaving” traffic and leads to effective congestion control and better services for rate-adaptive applications. Strict QoS guarantees, such as throughput or delays, can also be ensured by restricting the admission of traffic. A. K. Parekh and R. G. Gallager, “A Generalized Processor Sharing Approach to Flow Control in Integrated Services Networks-the Single Node Case,” IEEE/ACM Trans. on Networking, 344-57 (June, 1993), demonstrate that GPS guarantees end-to-end delay for leaky-bucket constrained traffic. GPS is an idealized discipline that cannot be implemented since it assumes that the server transmits more than one flow simultaneously and that the traffic is infinitely divisible. GPS serves as a model for sharing a server among flows with respect to their weights. A number of packetized approximations to GPS have been devised. Implementations of GPS, known as Weighted Fair Queuing (WFQ), can be found in current commercial routers or switches as well as in some servers which provide differentiated qualities of service to distinct classes of clients. See, for example, J. Blanquer et al., “Resource Management for QoS in Eclipse/BSD,” Proc. of the First FreeBSD Conference, Berkeley, Calif. (Oct., 1999).

An increased dependence on network services and the growing demand for bandwidth have generated the need for incremental scaling techniques. Grouping multiple links into a single logical interface has emerged as a popular bandwidth scaling method for high throughput switches and servers. Numerous implementations of aggregation techniques between servers, routers and switches are currently deployed in various networks. Multi-server systems arise in a number of applications including link aggregation, multiprocessors and multi-path storage I/O. These existing implementations provide a number of techniques for load balancing the traffic among the interfaces but they do not address the provision of QoS over these aggregated links.

While GPS-based service disciplines have been extensively studied for scheduling a single link, they have not been applied to aggregated links or other resources. The provisioning of such systems is naturally described as a function of the total link capacity rather than for each of the links. This calls for a reference system that consists of a single GPS server operating at a rate equal to the sum of the underlying servers' rates. A need therefore exists for a method and apparatus for proportionally sharing multiple servers among competing flows. A further need exists for a method and apparatus for ensuring service guarantees for shared multiple servers.

### SUMMARY OF THE INVENTION

Generally, a method and apparatus are disclosed for proportional sharing of multiple servers among competing flows, such as packets in a network environment or blocks of data in an aggregated data storage environment. The present invention extends single server weighted fair queuing (WFQ) principles to a multi-server system consisting of N servers each operating at a rate of r, referred to as a multi-server fair queuing (MSFQ) system, to provide an output rate of Nr. The present invention implements an aggregated resource scheduling process to proportionally share the multiple servers among the competing flows.

Although MSFQ and its single-server counterpart WFQ are based on the same policies for selecting the next packet to be serviced, MSFQ does not share some of the properties of WFQ. As a result, delay and service properties of MSFQ do not trivially follow from the single server case. For example, during a busy period consisting of the transmission of a single packet, GPS will transmit the packet at full rate, Nr, while the MSFQ server will only use one of its N servers so the packet would be transmitted at a rate of r. In this case, by the time GPS has finished the job (end of GPS busy period), the MSFQ server still has the last

$$\frac{( N - 1 ) L}{N}$$

bits of the packet left to transmit.

Under MSFQ, work from previous busy periods can accumulate, either at the beginning or in the middle of a busy period. Nonetheless, it has been found that the amount of work accumulating using MSFQ is bounded. To provide service guarantees to flows under a multi-server system, the bounded work backlog implies the need for an extra buffer space of (N−1)Lₘₐₓ, where Lₘₐₓ denotes the maximum packet length.

The MSFQ techniques of the present invention can lead to a reordering of packets, since MSFQ packets may not have a departure time, dₚ, in increasing order of scheduling time and due to the “late” arrival of packets. Given a load that must be scheduled before packet k, a work conserving service discipline schedules packet k latest, if the load is equally divided among the N servers such that all of them finish the work at the same time.

The MSFO system of the present invention closely approximates a GPS system in terms of the delay a packet can experience and the cumulative service a flow receives. The MSFQ algorithm demonstrates a maximum packet delay for all packets, p, as follows:

$${\overline{d}}_{p} - {d}_{p} \leq \frac{( N - 1 ) {L}_{p}}{Nr} + \frac{{L}_{max}}{r}$$

where N is the number of resources, Lₘₐₓ denotes the maximum packet length, Lₚ denotes the length of a given packet, p, \overline{d}ₚ and dₚ denote the departure time of the packet under MSFQ and GPS, respectively, and r is the rate of each of the resources. The maximum amount by which the service a given flow receives under GPS exceeds the service the flow receives under MSFQ, can be specified for any τ as follows:

Wᵢ(0,τ)−\overline{W}ᵢ(0,τ)≦NLₘₐₓ,

where W(0, t) and \overline{W}(0,τ) denote the total number of bits serviced by GPS and MSFQ, respectively, by time τ.

According to another aspect of the invention, the amount of service a flow receives in the packetized system does not exceed arbitrarily the amount it would have received under GPS. The fairness of a packetized discipline is measured by the maximum difference of the amount of service any flow receives within any interval to the one the flow would have received under GPS. The general MSFQ algorithm could schedule packets much earlier than the reference system, causing the discipline to favor some flows and behave in a bursty way over given periods of time. Thus, an alternate embodiment of the MSFQ algorithm, referred to herein as the MSF²Q algorithm, extends the single server work of the well-known WF²Q method to prevent bursty scheduling and to maintain the work conserving property. The WF²Q method restricts the packets eligible for scheduling to only the ones that have already started service in the GPS system by inserting a packet regulator at the exit of the flow queues.

The MSF²Q algorithm provides a packetized service discipline for multi-server systems that provides bounded fairness and generates “smooth” schedules. At time t, when a server is idle and there is a packet waiting for service, MSF²Q schedules among the flows that satisfy the following expression:

$${\hat{W}}_{i} ( 0 , t ) < {W}_{i} ( 0 , t ) or ( {\hat{W}}_{i} ( 0 , t ) = {W}_{i} ( 0 , t ) and {\hat{o}}_{i} < ⌈ \frac{{r}_{i} ( t )}{r} ⌉ ) ,$$

the packet that would complete service in the GPS system earliest. ôᵢ(t) is the number of outstanding flow i packets at the MSF²Q system at time t. The final term in the above equation provides a constraint to guarantee timing (packets are not scheduled any earlier than the time indicated by this parameter).

A more complete understanding of the present invention, as well as further features and advantages of the present invention, will be obtained by reference to the following detailed description and drawings.

### BRIEF DESCRIPTION OF THE DRAWINGS

FIG. 1 illustrates a system model employed by the present invention;

FIG. 2 illustrates an idealized model consisting of a single GPS server with an output rate of Nr;

FIG. 3 illustrates an example of a backlog being accumulated in both the MSFQ case and not in the GPS case;

FIG. 4 illustrates the queued packets at time 0 in an example where 11 flows share four output servers;

FIG. 5 depicts the packet scheduling of the example of FIG. 4 in the ideal GPS system;

FIG. 6 depicts the packet scheduling of the example of FIG. 4 in the MSFQ system of the present invention;

FIG. 7 depicts the packet scheduling of the example of FIG. 4 in the MSFQ system using WF²Q techniques;

FIG. 8 depicts a non-work conserving property that results from scheduling the packets of FIG. 4 in the MSFQ system using WF²Q techniques;

FIG. 9 depicts the scheduling the packets of FIG. 4 in the MSFQ system according to another embodiment of the present invention, referred to as MSF²Q; and

FIG. 10 is a flow chart describing an aggregated resource scheduling process incorporating features of the present invention.

### DETAILED DESCRIPTION

The present invention provides a method and apparatus for proportional sharing of multiple servers among competing flows, such as packets of a given type in a network environment or blocks of data of a given type in an aggregated data storage environment. There are numerous applications utilizing multi-server systems that can benefit from the service guarantees provided by the present invention, such as multiple network adapters for connecting a web or file server to a switch, or multiple input/output (I/O) channels for attaching a host to a Redundant Array Of Inexpensive Disks (RAID) server. Such network and storage connections can be modeled as a packet system with multiple servers. It is noted that the network and storage connections can be logical connections or physical connections, such as network interfaces or a SCSI interface. It is further noted that the term “flow,” as used herein, is intended to encompass the flow of data in a network environment and a flow of data in a data storage environment.

The problem of sharing multiple servers can be approached by partitioning the flows among the servers and scheduling them separately within each partition. One of the disadvantages of this technique, however, is that bandwidth fragmentation can easily occur when the sum of the flow weights is not balanced across all partitions. Moreover, aside from the fragmentation problem, this technique also has drawbacks in handling sporadic flows. For example, it is quite common for a large number of applications to frequently switch flows between backlogged and idle states or to make extensive use of relatively short-lived connections. This partitioning approach is also cumbersome to deal with in the case where weight assignments result in bandwidth shares for a flow that exceeds the rate of a single server. The present invention provides an alternative approach to sharing multi-servers where a packet of any flow can be serviced at any of the servers.

As discussed hereinafter, the present invention recognizes that many of the fair queuing results that were previously obtained for single server systems do not directly apply to multi-server systems. This is because the rate at which the packetized multi-server system operates may vary over time and thus differ from the rate of the reference system. Furthermore, the packetized multi-server system may reorder the packets to remain work-conserving. Initially, a background discussion is provided on the Generalized Processor Sharing discipline. Thereafter, a discussion is provided of the singular properties of the multi-server disciplines, followed by a discussion of the maximum differences in packet departure and per-flow service discrepancy with respect to GPS. According to another aspect of the invention, a new MSF²Q method provides tighter fairness guarantees which lead to smoother schedules in finer time scales.

### Generalized Processor Sharing Principles

As previously indicated, Generalized Processor Sharing (GPS) is a service discipline defined for sharing a server proportionally among a set of flows. A GPS server operates at a fixed rate r and is work-conserving. A positive real number φᵢ is assigned for each flow, i. Let F denote the set of flow indices. At any given time, a flow is either backlogged or idle. A flow is backlogged at time t if some of the flow's traffic is queued at time t. Otherwise, the flow is idle. Let Wi(τ, t) be the amount of traffic for flow i served in the interval {τ, t}.

Then, a GPS server is defined as one for which:

$$\frac{{W}_{i} ( τ , t )}{{W}_{j} ( τ , t )} \geq \frac{{φ}_{i}}{{φ}_{j}} , j ∈ F \qquad ( 1 )$$

holds for any flow i that is continuously backlogged during the interval {τ, t}. The weight of a flow determines the proportion of the server bandwidth that a flow receives when it is backlogged. During any time interval {τ, t}, when the set of backlogged flows, denoted by F(τ, t), is unchanged, a GPS server guarantees to a flow i, iεF (τ, t), a rate of

$$\frac{{φ}_{i}}{{\sum }_{j ∈ F ( τ , t )}^{} {φ}_{j}} r .$$

We denote the instantaneous rate of a flow i is denoted by rᵢ(t).

For strict QoS guarantees, then an admission mechanism is required so as to limit access and bandwidth shares. For example, by fixing the set of flows, a GPS server can guarantee to each flow i a minimum service rate of rᵢ:

$${r}_{i} = \frac{{φ}_{i}}{{\sum }_{j ∈ F}^{} {φ}_{j}} r .$$

### Proportional Sharing Of Multi-Server Systems

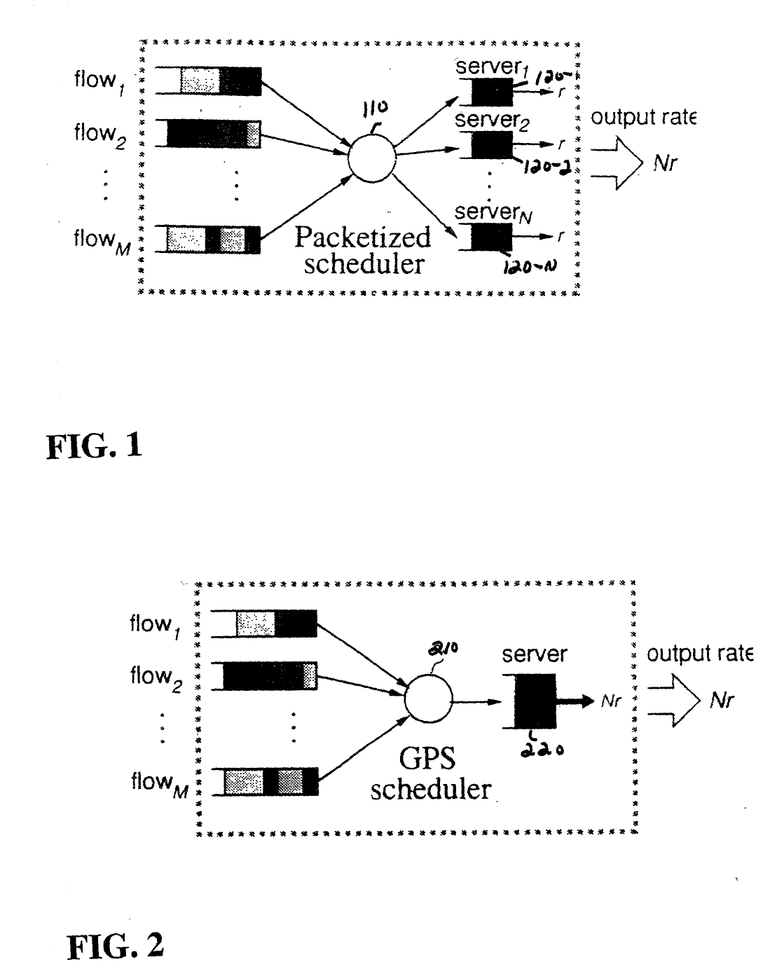

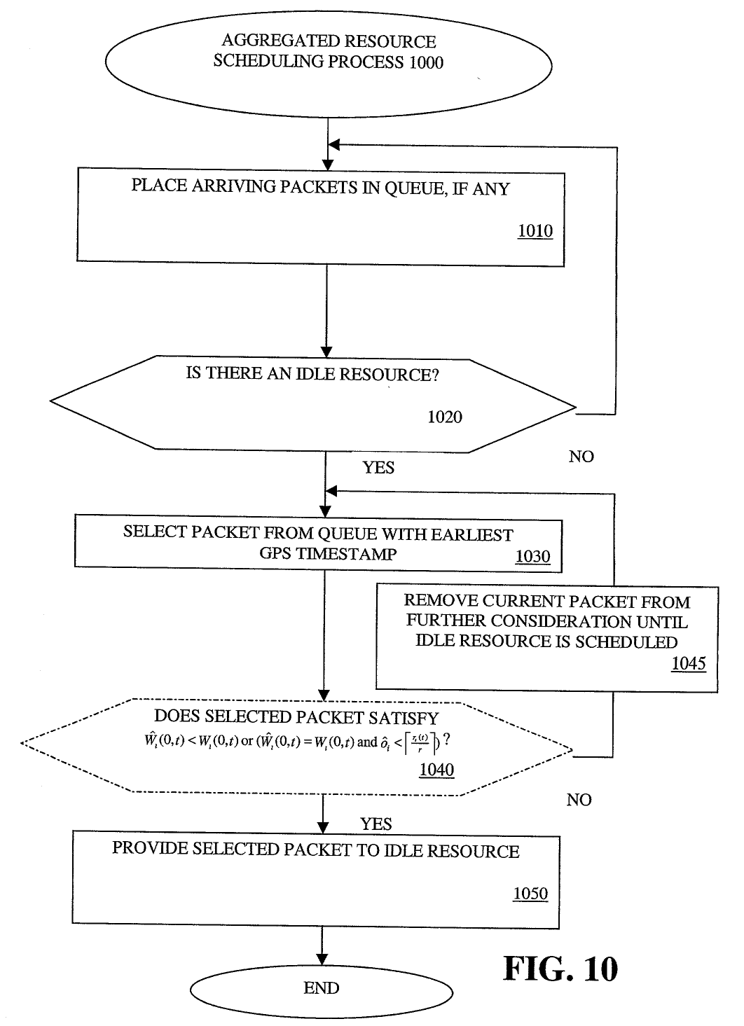

The system model employed by the present invention, shown in FIG. 1, consists of N servers 120-1 through 120-N, each operating at a fixed rate, r, to provide an output rate of Nr. A packetized scheduler 110 implements an aggregated resource scheduling process 1000, discussed below in conjunction with FIG. 10, to proportionally share the multiple servers 120-1 through 120-N among the competing flows (flow 1 through flow M). FIG. 2 illustrates an idealized model consisting of a single GPS server 220 with an output rate of Nr. The GPS server 220 is referred to as a (GPS, 1, Nr) system denoting one server with an output rate of Nr being scheduled by a GPS scheduler 210 with the GPS discipline.

Comparing the packetized disciplines against such a system allows the flows to be guaranteed a proportion of the total server capacity regardless of the value of N. This allows the proportions to remain valid without intervention when increasing the number of servers in the packetized system. For example, adding new interfaces to the link aggregation group of a high throughput web server will not change the proportions in which the different classes of services are served and will allow for the expansion of their minimum guaranteed rates. It is assumed that the arrival process to the packetized scheduling discipline is identical to that of the GPS discipline. The arrival time of a packet p is denoted by aₚ.

### Packetized Fair Queuing Discipline for Multi-Servers

The WFQ packetized fair queuing service discipline is defined for a single server in A. Demers et al., “Design and Analysis of a Fair Queuing Algorithm,” Proc. of the ACM SIGCOMM, Austin, Tex. (September, 1989) and A. K. Parekh and R. G. Gallager, “A Generalized Processor Sharing Approach to Flow Control in Integrated Services Networks-the Single Node Case,” IEEE/ACM Trans. on Networking, 344-57 (June, 1993).

The present invention extends such single server WFQ packetized fair queuing principles to a multi-server system consisting of N servers each with a rate of r, referred to as a (MSFQ, N, r) system. As used herein, the terms GPS and MSFQ systems/servers are used to denote the (GPS, 1, Nr) and (MSFQ, N, r) systems respectively, without explicitly stating their number of servers and their rate. When a server is idle and there is a packet waiting for service, MSFQ schedules the “next” packet. The “next” packet is defined as the first packet that would complete service in the (GPS, 1, Nr) system if no more packets were to arrive.

To consider how well a (MSFQ, N, r) system approximates a (GPS, 1, Nr) system, the worst case delay that a packet experiences under MSFQ is compared relative to GPS, and the discrepancy between the amount of traffic served for a flow under MSFQ is compared to the amount under GPS.

Although MSFQ and its single-server counterpart WFQ are both based on the same policy for selecting the next packet to be serviced, MSFQ does not share some of the useful properties of WFQ. As a result, delay and service properties of MSFQ do not trivially follow from the single server case.

The first obstacle pertains to the busy periods of MSFQ with respect to GPS. While WFQ busy periods coincide with those of GPS, this property does not hold for MSFQ. To illustrate this, take the case of a busy period consisting of the transmission of a single packet. While GPS will be able to transmit the packet at full rate, Nr, the MSFQ server will only be able to use one of its N servers so the packet would be transmitted at a rate of r. In this case, by the time GPS has finished the job (end of GPS busy period), the MSFQ server still has the last

$$\frac{( N - 1 ) L}{N}$$

last bits of the packet left to transmit.

When GPS is busy, MSFQ is busy. However, the converse is not true. Thus for any τ,

W(0,τ)≧\overline{W}(0,τ) (2)

where W(0, t) and \overline{W}(0,τ) denote the total number of bits serviced by GPS and MSFQ, respectively, by time τ. Since GPS and MSFQ busy periods do not coincide, the term busy period is used to refer to a busy period in the reference (GPS, 1, Nr) system.

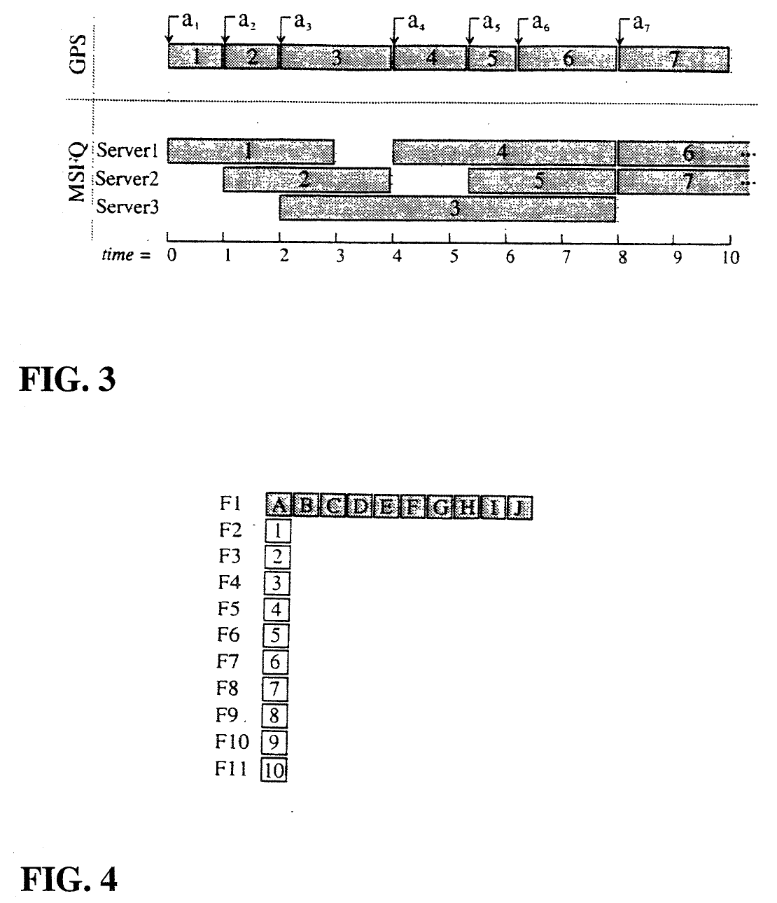

Furthermore, because they do not coincide, work from previous busy periods can accumulate under MSFQ. This may happen either at the beginning or in the middle of a busy period. FIG. 3 depicts a case in which a backlog is being accumulated in the MSFQ case and not the GPS case. In the example of FIG. 3, the packets arrive sequentially to the system such that there is always one packet at the GPS server being transmitted at full rate. It has been found that the amount of work accumulating using MSFQ is bounded.

### Buffer Requirements For Multi-Server Systems

Buffer requirements of a GPS system servicing leaky-bucket shaped flows are studied in A. K. Parekh and R. G. Gallager, “A Generalized Processor Sharing Approach to Flow Control in Integrated Services Networks-the Single Node Case,” IEEE/ACM Trans. on Networking, 344-57 (June, 1993). To provide similar guarantees to such flows under a multi-server packet system, the bounded backlog implies the need for an extra buffer space of (N−1)Lₘₐₓ, where Lₘₐₓ denotes the maximum packet length.

### Packet Reordering For Multi-Server Systems

Another difference between multi-server and single-server schedulers is the discrepancy of packet departure times with respect to GPS. Let dₚ be the time at which packet p departs from a (GPS, 1, Nr) system. MSFQ packets may not depart in increasing order of dₚ. The order in which packets depart under MSFQ may be different than the order in which MSFQ schedules (i.e., begins transmitting/servicing) packets, since packets of a flow may be concurrently in service at different servers of MSFQ. This type of reordering does not occur in the single-server case.

A second reason for reordering is due to “late” arrival of packets. Suppose that a server becomes idle at time r. The next packet to depart under GPS may not have arrived at time r. Since the server has no knowledge of when this packet will arrive, MSFQ cannot be both work conserving and also schedule packets always in increasing order of dₚ. This type of reordering also exists in the single-server packetized systems but the problem is intensified in the multi-server case.

Given a load that must be scheduled before packet k, a work conserving service discipline schedules packet k latest, if the load is equally divided among the N servers such that all of them finish the work at the same time.

### Maximum Packet Delay

Let \overline{d}ₚ be the time at which packet p departs from the (MSFQ, N, r) system. Lₘₐₓ denotes the maximum packet length. The following scenario is possible. All the N servers are idle before time t. N packets of flow 1, each with a length Lₘₐₓ, arrive at time t. Packet p of flow 2 arrives immediately after t. Let φ₂>>φ₁. Thus, dₚ is slightly after

$${a}_{p} + \frac{{L}_{p}}{Nr} ,$$

where Lₚ is the length of packet p. However, \overline{d}ₚ is slightly before

$${a}_{p} + \frac{{L}_{max}}{r} + \frac{{L}_{p}}{r} ,$$

since when packet p arrives, each server under MSFQ is transmitting a packet, which arrived before packet p whose GPS finishing time is after dₚ. Thus, \overline{d}ₚ−dₚ is close to:

$$\frac{( N - 1 ) {L}_{p}}{Nr} + \frac{{L}_{max}}{r} .$$

We have found that this example is the worst case delay a packet experiences under MSFQ compared to GPS. Thus, for all packets, p:

$${\overline{d}}_{p} - {d}_{p} \leq \frac{( N - 1 ) {L}_{p}}{Nr} + \frac{{L}_{max}}{r}$$

where N is the number of resources, Lₘₐₓ denotes the maximum packet length, Lₚ denotes the length of a given packet, p, \overline{d}ₚ and dₚ denote the departure time of the information under MSFQ and GPS, respectively, and r is the rate of each of the resources.

### Per-Flow Service Discrepency

Let Wᵢ(t, τ) and \overline{W}ᵢ(t,τ) be the amount of service (in bits) that flow i received in the interval {t, τ} under GPS and MSFQ, respectively.

Consider a scenario where an arrival pattern for flow 2 consists of N packets each with length Lₘₐₓ arriving slightly after t. Since N servers of MSFQ are idle at t, it is known that Wᵢ(0, t)=\overline{W}ᵢ(0, t). Under GPS at time

$$t + \frac{{L}_{max}}{r} ,$$

flow 2 receives almost another NLₘₐₓ bits of service, whereas under MSFQ, flow 2 does not get any service in

$$[ t , t + \frac{{L}_{max}}{r} ] . Thus , {W}_{i} ( 0 , t + \frac{{L}_{max}}{r} ) \approx {\overline{W}}_{i} ( 0 , \frac{{L}_{max}}{r} ) + {NL}_{max} .$$

This example is the maximum amount at which the service a flow receives under GPS exceeds the service a flow receives under MSFQ. Thus, for any τ:

Wᵢ(0, τ)−\overline{W}ᵢ(0, τ)≦NLₘₐₓ.

For a more detailed discussion of the maximum packet delay and per-flow service discrepancies, see Josep M. Blanquer and Banu Ozden, “Fair Queuing for Aggregated Multiple Links,” ACM SIGCOMM '01, 185-97, San Diego, Calif. (Aug. 27, 2001), incorporated by reference herein.

### Fairness

It has been shown that a (MSFQ, N, r) system closely approximates a (GPS, 1, Nr) system in terms of the delay a packet can experience and the cumulative service a flow receives. Another desirable property is to ensure that the amount of service a flow receives in the packetized system does not exceed arbitrarily the amount it would have received under GPS. This property leads to smoother output and “better” fairness.

The fairness of a packetized discipline is measured herein by the maximum difference of the amount of service any flow receives within any interval to the one the flow would have received under GPS. If the maximum difference is independent of the set of flows, the packetized discipline is said to provide bounded fairness. MSFQ does not enjoy this property since there is no constant c for which \overline{W}ᵢ(t,τ)≧Wᵢ(t,τ)−c holds for every interval [t,τ]. Thus, MSFQ can largely diverse from the ideal discipline by being far ahead in the completed work for a flow.

Service disciplines with bounded fairness are especially desirable for rate adaptive applications and for congestion control algorithms. Being able to schedule packets much earlier than the reference system, can cause the discipline to favor some flows and behave in a bursty way over given periods of time. This problem is addressed for the single server packetized system in J. C. R. Bennett and H. Zhang, “WF²Q: Worst-Case Fair Weighted Fair Queueing,” Proc. of IEEE INFOCOM, San Francisco (March, 1996). Unfortunately, the solution presented by Bennet et al. does not apply directly to the multi-server case.

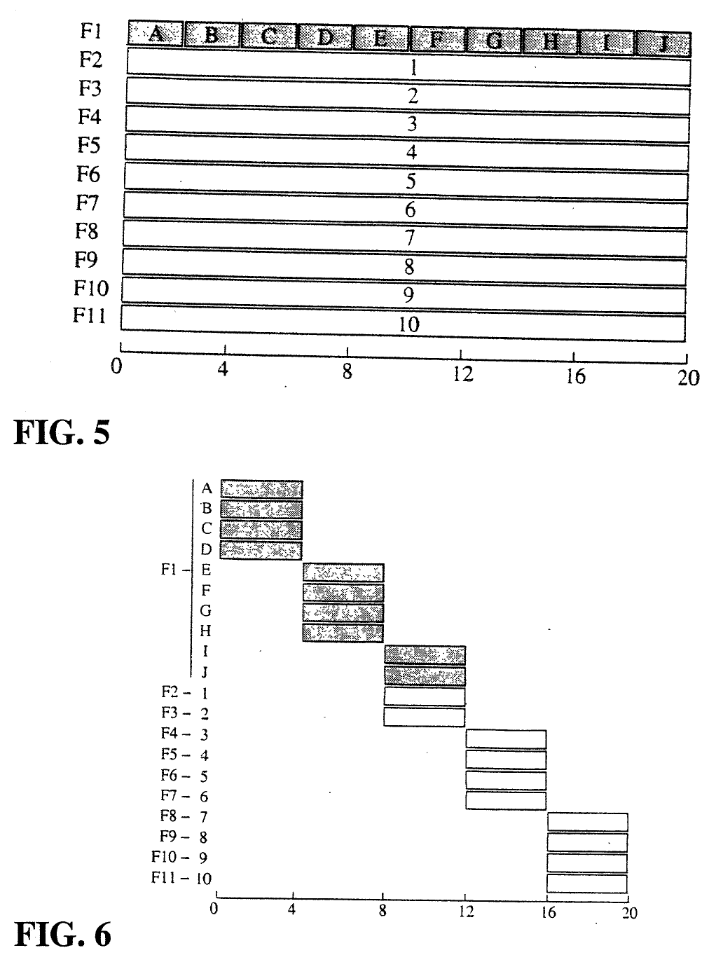

FIG. 4 illustrates the queued packets at time 0 in an example where 11 flows share four output servers. The first flow (F1) has a weight of 0.5 while each other flow (F2-F11) has a weight of 0.05. At time 0, all packets have already arrived at the system. Flow 1 (F1) has 10 packets while the other flows have only one packet each. For simplicity, all packets have the same length of L. FIG. 5 depicts the packet scheduling in the ideal GPS system. Since MSFQ schedules packets in increasing order of GPS departure times, all of flow 1 (F1) packets will be scheduled before the packets of any other flow. FIG. 6 depicts the packet scheduling in the MSFQ system of the present invention. It can be seen that some of flow 1 packets are scheduled much earlier with the MSFQ system (FIG. 6) than the corresponding GPS discipline (FIG. 5). For example, packet J is completed at time 12 in FIG. 6, which is 8 units earlier than in the ideal system of FIG. 5. It can be shown that this “earliness” can be arbitrarily large and depends on the number of existing flows in the system.

The WF²Q method of Bennet et al. provided a solution to this problem for single WFQ servers. The WF²Q method consisted of restricting the packets eligible for scheduling to only the ones that have already started service in the GPS system. The scheduling of these packets was still done according to the WFQ discipline, that is in non-decreasing order of GPS finishing times. Conceptually, the WF²Q method inserted a packet regulator at the exit of the flow queues which delayed the eligibility of the packets to the WFQ scheduler. Unfortunately, it has been found that the direct application of this technique to multi-server systems does not fix the undesired burstiness problem and moreover, it makes the discipline non-work conserving.

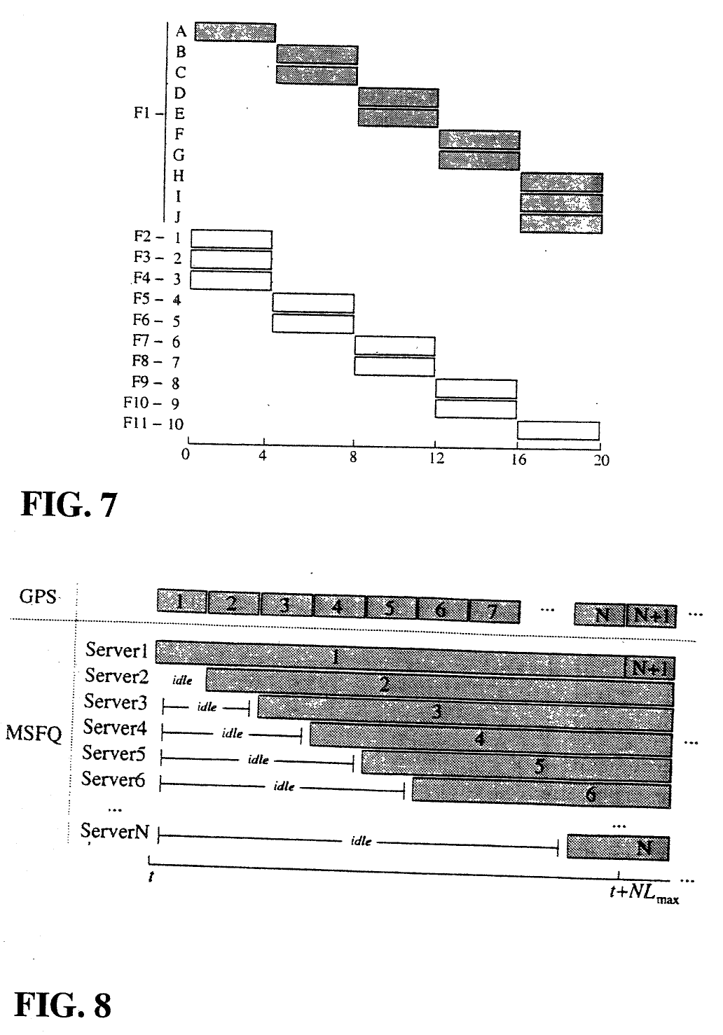

The burstiness problem is illustrated in FIG. 7, which shows the scheduling output of the example of FIG. 4 using a multi-server system with the WF²Q discipline. It can be seen that packets from the first flow can still experience transmission periods that are as bursty, as the previous case of FIG. 6. Thus, the application of WF²Q to the multi-server case still does not lead to smooth schedules. To illustrate that this regulator technique results into a non-work-conserving scheduling discipline, take the case where a large number of maximum length packets from a single flow are queued in the system at time t. In the GPS case, the queued packets will be scheduled sequentially at full rate of the server (Nr), irrespective of the weights of the flows.

In this scenario, as shown in FIG. 8, the second packet will not be eligible in the packetized system until the same packet gets scheduled in GPS, that is at

$$t + \frac{{L}_{max}}{Nr} .$$

Therefore, no matter how many servers there are available until that moment, they will remain idle even though there is work to be done in the system. This situation will continue to repeat until most of the first packet has been transmitted

$$( t + \frac{( N - 1 ) {L}_{max}}{N} )$$

on one of the servers.

The WF²Q regulator technique can be modified to become work-conserving. A simple extension would be if noneligible packets were allowed to be scheduled to an idle server in cases where no other eligible packets were queued in the system. However, this modified version of WF²Q does not enjoy the simple extension of the bound on \overline{W}ᵢ(0,τ)−Wᵢ(0,τ) from L_{i,max} in the single server case to NL_{i,max} in the multi-server case.

Consider an example with 2 flows sharing 10 output servers. The first flow (F1) has a weight 0.9 while the second one has a weight 0.1. L_{2,max} is 1. All the packets of flow 2 (F2) arrive at time 0 and each has a length of L_{2,max}. The first packet of flow 1 arrives at time 0 and has a length 100. Flow 1 arrival rate is 0.9Nr. Thus, the second packet of flow 2 arrives at time 100/0.9. At time 0, the first packets of flow 1 and 2 are eligible and they are scheduled. Since there are 8 idle servers and no eligible packets, to keep the system work-conserving, the non-eligible packets in the system are scheduled in the order of their GPS finishing times. Until the second packet of flow 1 arrives, 99 packets of flow 2 are scheduled. At this time, \overline{W}₂(0,100/0.9)−W₂(0,100/0.9) is approximately 88.8, not NL_{2,max}=10.

### MSF²Q

According to a further aspect, the present invention aims to devise a packetized service discipline for multi-server systems that provides bounded fairness and generates “smooth” schedules. To this end, a new discipline is introduced, referred to as a (MSF²Q, N, r) system or simply MSF²Q. A packet is outstanding if it is being transmitted or picked for transmission by the packetized system. Let ôᵢ(t) denote the number of outstanding flow i packets at the MSF²Q system at time t. The work completed for flow i under MSF²Q over the interval {τ, t} is denoted by Ŵᵢ(τ, t). At time t, when a server is idle and there is a packet waiting for service, MSF²Q schedules among the flows that satisfy

$${\hat{W}}_{i} ( 0 , t ) < {W}_{i} ( 0 , t ) or ( {\hat{W}}_{i} ( 0 , t ) = {W}_{i} ( 0 , t ) and {\hat{o}}_{i} < ⌈ \frac{{r}_{i} ( t )}{r} ⌉ ) ,$$

the packet that would complete service in the GPS system earliest. The final term in the above equation provides a constraint to guarantee timing (packets are not scheduled any earlier than the time indicated by this parameter).

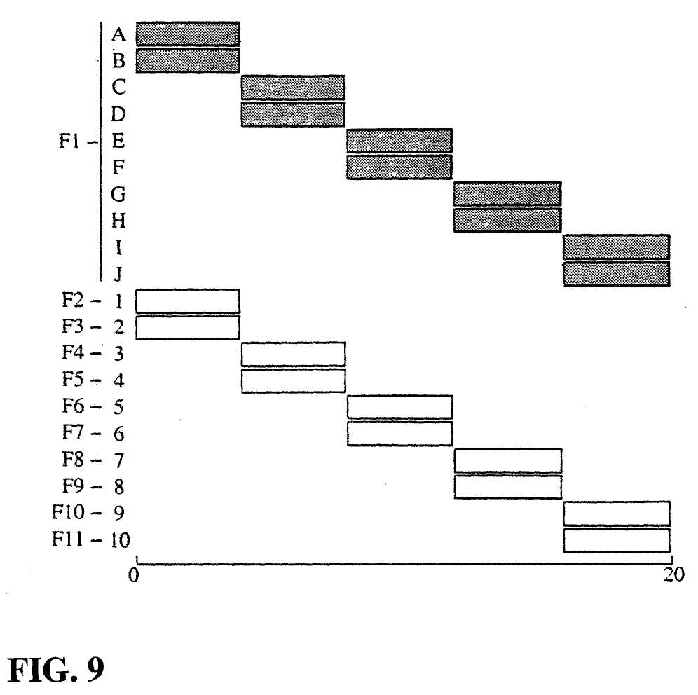

MSF²Q reduces to WF²Q if the number of servers is one. FIG. 9 depicts the output of MSF²Q in the previous scenario of the example of FIG. 4. It can be seen that the resulting service is the closest achievable to the ideal discipline.

The bound for the extra amount of service a flow can receive at any time τ under MSF²Q compared to GPS is given by:

Ŵᵢ(0,τ)−Wᵢ(0,τ)≦NL_{i,max}

for any time τ and flow i, where L_{i,max} denotes the maximum packet length of flow i.

### Applications

There are numerous existing system architectures that follow very closely the multi-server model described herein. These systems can benefit from multi-server fair queuing disciplines to provide QoS guarantees on the access of their resources.

Link Aggregation is one example in the networking area. Ethernet link aggregation is a technique that allows the logical grouping of several network interfaces to allow for better scalability and fault-tolerance. The use of such techniques is becoming increasingly popular since it provides a cost-effective and fault tolerant solution for incrementally scaling the network I/O capacity of the current high-end switches and servers. Many IEEE 802.3ad standard and vendor-specific implementations are currently available. The number of aggregated links on the existing systems varies largely among vendors and currently ranges from two to eight Fast/Gigabit Ethernet ports in either servers or switching elements. Although the available implementations typically utilize load balancing techniques such as round robin or static parameter hashing, none of these systems provide QoS guarantees over aggregated links.

Algorithms such as MSF²Q can also be implemented to provide QoS guarantees in the access of storage I/O. For midrange and high-end storage systems, it is common to connect the RAID system to a host (e.g., Web server) with multiple SCSI or FC channels to improve the I/O performance. A number of storage vendors (e.g., EMC) are offering multi-path I/O software for load balancing and failover among the channels. Furthermore, the need for fairness and service guarantees for storage I/O is growing with the consolidation of clients' data and applications in the service providers' data centers. Since storage I/O traffic can be modeled as variable size packets, MSF²Q-type algorithms can be used to provide fair sharing of multiple I/O channels.

When distributing traffic across multiple links, as in the previous examples, the order in which the packets are received at the destination may be different from the order in which they were originally sent. Potential out-of-order delivery does not affect all applications. However, it may lower the expected end-to-end performance, for example, of TCP connections, since out-of-order reception of TCP packets may cause unnecessary retransmissions. Since current systems contain only a few links but handle a large number of flows, out-of-order-delivery due to multiple paths is not expected to be common. It is also important to note, that rather than being an artifact of our Fair Queuing algorithm, this misordering is an inherent problem of balancing load among multiple outgoing links and its impact should be studied.

FIG. 10 is a flow chart describing an aggregated resource scheduling process 1000 incorporating features of the present invention. As shown in FIG. 10, the aggregated resource scheduling process 1000 initially places arriving packets from the various M flows, if any, in the appropriate queue for the corresponding flow during step 1010. Thereafter, a test is performed during step 1020 to determine if there is an idle resource available to process a queued packet. If it is determined during step 1020 that there are no idle resources, then program control returns to step 1010 until there is an idle resource available to process a queued packet.

Once it is determined during step 1020 that there is an idle resource available to process a queued packet, then a packet is selected from the queue with the earliest GPS departure timestamp during step 1030. The earliest GPS departure timestamp can be computed, for example, in accordance with the teachings of A. K. Parekh and R. G. Gallager, “A Generalized Processor Sharing Approach to Flow Control in Integrated Services Networks—the Single Node Case,” IEEE/ACM Trans. on Networking, 344-57 (June, 1993), incorporated by reference herein.

An optional test is performed in an MSF²Q implementation during step 1040 to determine if packet regulator constraint is satisfied. In particular, it is determined whether at time t, the selected packet satisfies the following constraint:

$${\hat{W}}_{i} ( 0 , t ) < {W}_{i} ( 0 , t ) or ( {\hat{W}}_{i} ( 0 , t ) = {W}_{i} ( 0 , t ) and {\hat{o}}_{i} < ⌈ \frac{{r}_{i} ( t )}{r} ⌉ ) ,$$

where W(0, t) and W(0,τ) denote the total number of bits serviced by GPS and MSFQ, respectively, by time t and ôᵢ(t) denotes the number of outstanding flow i packets at the MSF²Q system at time t. If it is determined during step 1040 that the packet regulator constraint is not satisfied, then the current packet is removed from consideration during step 1045 until the current idle resource is scheduled, before program control returns to step 1030.

If, however, it is determined during step 1040 that the packet regulator constraint is satisfied, then the selected packet is provided to the idle resource during step 1050. If there is more than one idle resource, a particular idle resource can be selected by a variety of techniques without violating the characteristics of the algorithm. Common techniques, such as round robin, can naturally be applied to this effect. More complex algorithms can also be applied that consider not only the number of resources, but also the current characteristics of the queued packets (such as packet size and queue lengths).

It is to be understood that the embodiments and variations shown and described herein are merely illustrative of the principles of this invention and that various modifications may be implemented by those skilled in the art without departing from the scope and spirit of the invention.

### We claim:

1. A method for ensuring a desired level of service over a plurality of resources to a plurality of flows, comprising the steps of:
providing a buffer for storing said flows; and
providing information from said buffer to one or more idle ones of said plurality of resources, wherein said plurality of resources are proportionally shared among said plurality of flows.

2. The method according to claim 1, wherein said resources are network connections.

3. The method according to claim 1, wherein said resources are storage connections.

4. The method according to claim 1, further comprising the step of selecting one or more of a plurality of idle resources.

5. The method according to claim 1, further comprising the step of selecting one or more of said flows from said buffer based on an earliest GPS timestamp.

6. The method according to claim 1, further comprising the step of providing an information regulator to ensure that:
at time t, the selected information satisfies the following constraint:
$${\hat{W}}_{i} ( 0 , t ) < {W}_{i} ( 0 , t ) or ( {\hat{W}}_{i} ( 0 , t ) = {W}_{i} ( 0 , t ) and {\hat{o}}_{i} < ⌈ \frac{{r}_{i} ( t )}{r} ⌉ ) ,$$
where W(0, t) and Ŵ(0,τ) denote the total number of bits serviced by gps and msfq, respectively, and ôᵢ(t) denotes the number of outstanding flow i packets at an MSF²Q system at time t:

7. The method according to claim 1, wherein said buffer has a size that exceeds a GPS equivalent buffer by up to (N−1)Lₘₐₓ, where N is the number of said resources and Lₘₐₓ denotes the maximum packet length.

8. The method according to claim 1, wherein said method demonstrates a maximum delay for said information, p, as follows:
$${\overline{d}}_{p} - {d}_{p} \leq \frac{( N - 1 ) {L}_{p}}{Nr} + \frac{{L}_{max}}{r}$$
where N is the number of resources, Lₘₐₓ denotes the maximum information length, Lₚ denotes the length of a given information, p, \overline{d}ₚ and dₚ denote the departure time of the information under MSFQ and GPS, respectively, and r is the rate of each of said resources.

9. The method according to claim 1, wherein said method demonstrates a maximum amount by which the service received under GPS exceeds the service received under MSFQ, specified for any r as follows:
W(0,τ)−\overline{W}(0,τ)≦(N−1)Lₘₐₓ
where N is the number of resources, Lₘₐₓ denotes the maximum information length, W(0, τ) and \overline{W}(0,τ) denote the total number of bits serviced by GPS and MSFQ, respectively, by time τ.

10. The method according to claim 1, wherein said method demonstrates a maximum amount by which the service a given flow receives under GPS exceeds the service the flow receives under MSFQ, specified for any τ, as follows:
W(0,τ)−\overline{W}ᵢ(0,τ)≦NLₘₐₓ,
where W(0, t) and \overline{W}(0,τ) denote the total number of bits serviced by GPS and MSFQ, respectively, by time τ.

11. The method according to claim 6, wherein said method demonstrates a maximum amount by which the service a given flow receives under GPS lags the service the flow receives under MSF²Q, specified for any τ, as follows:
Ŵᵢ(0,τ)−Wᵢ(0,τ)≦NL_{i,max}
where W(0, t) and Ŵ(0,τ) denote the total number of bits serviced by GPS and MSF²Q, respectively, by time τ.

12. A system for ensuring a desired level of service over a plurality of resources to a plurality of flows, comprising:
a buffer for storing said flows;
a memory that stores computer-readable code; and
a processor operatively coupled to said memory, said processor configured to implement said computer-readable code, said computer-readable code configured to:
provide information from said buffer to an idle one or more of said plurality of resources, wherein said plurality of resources are proportionally shared among said plurality of flows.

13. The system according to claim 12, wherein said resources are network connections.

14. The system according to claim 12, wherein said resources are storage connections.

15. The system according to claim 12, wherein said processor is further configured to select one of a plurality of idle resources.

16. The system according to claim 12, wherein said processor is further configured to select one or more of said flows from said buffer based on an earliest GPS timestamp.

17. The system according to claim 12, wherein said processor is further configured to provide an information regulator to ensure that:
at time t, the selected information satisfies the following constraint:
$${\hat{W}}_{i} ( 0 , t ) < {W}_{i} ( 0 , t ) or ( {\hat{W}}_{i} ( 0 , t ) = {W}_{i} ( 0 , t ) and {\hat{o}}_{i} < ⌈ \frac{{r}_{i} ( t )}{r} ⌉ ) ,$$
where W(0, t) and Ŵ(0,τ) denote the total number of bits serviced by GPS and MSFQ, respectively, and ôᵢ(t) denotes the number of outstanding flow i packets at an MSF²Q system at time t.

18. The system according to claim 12, wherein said buffer has a size that exceeds a GPS equivalent buffer by up to (N−1)Lₘₐₓ, where N is the number of said resources and Lₘₐₓ denotes the maximum packet length.

19. The system according to claim 12, wherein said system demonstrates a maximum delay for said information, p, as follows:
$${\overline{d}}_{p} - {d}_{p} \leq \frac{( N - 1 ) {L}_{p}}{Nr} + \frac{{L}_{max}}{r}$$
where N is the number of resources, Lₘₐₓ denotes the maximum information length, Lₚ denotes the length of a given information, p, \overline{d}ₚ and dₚ denote the departure time of the information under MSFQ and GPS, respectively, and r is the rate of each of said resources.

20. The system according to claim 12, wherein said system demonstrates a maximum amount by which the service received under GPS exceeds the service received under MSFQ, specified for any τ as follows:
W(0,τ)−\overline{W}(0,τ)≦(N−1)Lₘₐₓ
where N is the number of resources, Lₘₐₓ denotes the maximum information length, W(0, t) and \overline{W}(0,τ) denote the total number of bits serviced by GPS and MSFQ, respectively, by time τ.

21. The system according to claim 12, wherein said method demonstrates a maximum amount by which the service a given flow receives under GPS exceeds the service the flow receives under MSFQ, specified for any τ, as follows:
Wᵢ(0,τ)−\overline{W}ᵢ(0,τ)≦NLₘₐₓ,
where W(0, t) and \overline{W}(0,τ) denote the total number of bits serviced by GPS and MSFQ, respectively, by time τ.

22. The system according to claim 17, wherein said method demonstrates a maximum amount by which the service a given flow receives under GPS lags the service the flow receives under MSF²Q, specified for any τ, as follows:
Ŵᵢ(0,τ)−Wᵢ(0,τ)≦NL_{i,max}
where W(0, t) and Ŵ(0,τ) denote the total number of bits serviced by GPS and MSF²Q, respectively, by time τ.

23. A system for ensuring a desired level of service over a plurality of resources to a plurality of flows, comprising the steps of:
a buffer for storing said flows; and
means for providing information from said buffer to an idle one or more of said plurality of resources, wherein said plurality of resources are proportionally shared among said plurality of flows.

24. The system according to claim 23, wherein said resources are network connections.

25. The system according to claim 23, wherein said resources are storage connections.

26. The system according to claim 23, further comprising means for selecting one of a plurality of idle resources.
